(19) United States
(12) Patent Application Publication
(10) Pub. No.: US 2007/0263388 A1
(43) Pub. Date: Nov. 15, 2007

(54) Illumination device of flexible lighting angle

(75) Inventors: Chieh-Lung Lai, Taiping City (TW); Jian-Shian Lin, Yilan City (TW); Li-Ling Lee, Qionglin Shiang (TW); Hung-Chun Li, Zhongli City (TW)

Correspondence Address: REED SMITH LLP;Suite 1400, 3110 Fairview Park Drive, Falls Church, VA, 22042, US

(73) Assignee: Industrial Technology Research Institute

(21) Appl. No.: 11/717,753

(22) Filed: Mar. 14, 2007

(30) Foreign Application Priority Data
May 12, 2006 (TW) 095145175

(51) Int. Cl. F21V 14/02

(52) U.S. Cl. 362/287

(57) ABSTRACT

An illumination device of flexible lighting angle is disclosed, which comprises: at least a directional light source, capable of emanating a light as it is electrically conducted to a control circuit while enabling the light angle of the light discharged therefrom to be adjustable; and a light guide cover, for receiving the at least one directional light source, having a light-control microstructure formed thereon while enabling the same to be further composed of a plurality of reflective/refractive microsurfaces. By adjusting the light-emitting angle of the directional light source for directing the discharged light to shine on different reflective/refractive microsurfaces of the light-control microstructure where it is reflected/refracted and discharged out of the light guide cover, the angle of the light being discharged out of the light guide cover is varied.

### FIELD OF THE INVENTION

The present invention relates to an illumination device of flexible lighting angle, and more particularly, to an illumination device, using light-emitting diodes (LEDs) as its light source and structured with a light-guide cover with light-control microstructure matching to the LEDs, which can vary the angle of the light being discharged out of the illumination device by adjusting the light-emitting angle of the LEDs and thus not only the light pattern preferred by a user can be achieved, but also the uniformity of area to be lighted by the illumination device is enhanced, so that the illumination device can be adapted as luminaires, signal indicators, or other light emitting apparatuses.

### BACKGROUND OF THE INVENTION

Conventional light sources can be divided into two types of light sources, which are point source and line source. As commonly known that tungsten-filament lamps and energy-saving light bulbs are point sources and fluorescent lamps are line source, all of the abovementioned lamps can only emanate light by an radiating manner such that their light angles are not adjustable.

One the other hand, light emitting diode (LEDs), that is gradually becoming popular and being used as light source of luminaires, is specified as planar source or so-called directional light source as it has the maximum emitted power in the direction perpendicular to the emitting surface. However, although LEDs are preferred as they are small in size, there are still many to be improved while applying the same in luminaires:
(1) As LED is a directional light source, with the maximum emitted power in the direction perpendicular to the emitting surface, that is not suitable to be used in conventional luminaires, a matching reflective cover or a bottom-lighting structure is required.
(2) As the brightness produced by a single LED is generally insufficient for most luminaires that it is usual for a luminaire to adopt a plurality of LEDs with fixed lighting angle as its light source, such Multi-LED luminaire with bottom-lighting structure will suffer problems, such as glare, limited illuminant area and unable to produce luminance with sufficient evenness, that cause discomfort to users.
(3) As the light emitting from an LED is fixed to a specific direction, the light angle of any reflective or refractive luminaire using such LED as its light source is also fixed so that it is unable to produce various patterns of light and light-emitting angles at will for meeting various luminance requirements and thus it is comparatively not flexible enough.
(4) In those conventional LED luminaires, LEDs are usually fixedly arranged on a circuit board so that it is required to dismantle and replace the whole circuit board even when there is only one LED fixed thereon is broken and required to be replaced, and it is difficult for a common consumer to maintain/repair such conventional LED luminaire by himself.
(5) It is ease to spot one broken LED or a portion of those in those conventional LED luminaires.

There are already many improvements relating to those shortcomings. One such improvement is a rotatable LED arrangement disclosed in U.S. Pat. No. 6,315,432, entitled “Light-emitting Diode (LED) device”, as seen in FIG. 1. In the rotatable LED arrangement shown in FIG. 1, the LED member 10 is assembled into and retained within a chamber of a retaining housing 11, whereas the chamber is designed to extend through a ball-like retaining portion 110 and a cylindrical portion 111 of the retaining housing 11 for retaining the LED member 10 therein while enabling the light-emitting portion of the LED member 10 to extend forward beyond the retaining housing 11. In addition, the assembled LED member 10 and the retaining housing 11 are then assembled into an opening 120 of a positioning base 12 in a manner that the ball-like retaining portion 110 of the retaining housing 11 engages within the non-closed spherical opening 120 of the positioning base 12 and the ball-like retaining portion 110 can be adjusted to properly rotate within the spherical opening 120. Therefore, if a detector element 3 is not previously positioned within a conical infrared covering zone 103 of the LED member 10 of the rotatable LED arrangement, the detector element 3 need not to be moved to fall within the conical infrared covering zone 103 of the LED member 10. What is needed is to readily adjust the ball-like retaining portion 110 of the rotatable LED arrangement for a suitable angle A to make the conical infrared covering zone 103 cover the detector 3. Furthermore, the conical infrared covering zone 103 of the rotatable LED arrangement can be easily adjusted to follow the tracks of the detector 3 in cases the detector 3 has no fixed positions. However, as the structure of such rotatable LED arrangement is so complicated and bulky, it is difficult to maintain and assemble. Moreover, the design of such rotatable LED arrangement limits the LED member 10 to only emit light toward the particular side thereof facing the detector 3 that it can not cover the whole terrain surrounding the arrangement. In addition, while applying such rotatable LED arrangement to any common luminaire, as the light emitting from such rotatable LED arrangement shoots directly toward the detector 3 and there is no reflective cover configured in such rotatable LED arrangement, it will suffer problems, such as glare, limited illuminant area and unable to produce luminance with sufficient evenness.

Another such improvement is an LED arrangement disclosed in U.S. Pat. No. 6,450,663, entitled “Light-emitting Diode Arrangement”, as seen in FIG. 2. The light-emitting-diode arrangement is substantially a vehicle signal light, having a beam direction 6 obliquely oriented relative to a base plane, includes a support plate 2 and a plurality of light-emitting diodes 3 arranged on the support plate 2, with the support plate 2 being arranged parallel to the base plane and the light-emitting diodes 3 each having a base body 4, inclined in the beam direction 6, which is oblique to the support plate 2, in which a first contact pin 10 arranged at a first end of each base body 4 of the light-emitting diodes 3 are inserted into and soldered at guide holes of the support plate 2, with a second contact pin 12 arranged at a second end opposite the first end extending into an adjacent opening 14, whereas the light-emitting diode 3 is tipped so that the second end of the base body 4 extends into the opening 14 and its underside facing toward the support plate 2 presses against an inner edge of the opening 14. As the inclination of the LED 3 is realized by the bending of the first contact pin 10 that LEDs of different inclinations can be achieved by bending the first contact pin 10 at different angle. However, the inclination angle of each LED 3 can not be adjusted at will multiple times since the first contact pin 10 might be broken after being bended several times. Moreover, the design of the carrier surface 19 and the opening 14 defines the range of the inclination of each LED 3 capable of being adjusted. In addition, similar to that shown in U.S. Pat. No. 6,315,432, while applying such rotatable LED arrangement to any common luminaire, as the light emitting from such rotatable LED arrangement shoots directly toward the detector 3 and there is no reflective cover configured in such rotatable LED arrangement, it will suffer problems, such as glare, limited illuminant area and unable to produce luminance with sufficient evenness.

As the two LED arrangements, shown respectively in the two aforesaid U.S. patents, both use conventional LEDs with two contact pins as their light sources, the problems troubling those prior-art LED luminaires will also be the problems of the two, such as it is unable to produce various light-emitting angles at will, and it is required to dismantle and replace the whole circuit board even when there is only one LED fixed thereon is broken, and so on. Currently, there is a type of tube-like LED, which is shaped like the conventional glass tube fuse and is capable of being driven to emit light simply by embedding the same into a conductive seat. The tube-like LED can be maintained and replaced easily that is commonly seen to be used as the top ceiling light for vehicles.

One such application relating the aforesaid tube-like LED is an LED arrangement disclosed in JP Pat. No. 2002324405, as shown in FIG. 3A and FIG. 3B. The lamp 1B is a transparent tube 4 having a substrate 16 arranged therein and two electrodes 5 respectively formed at two ends thereof, in which a plurality of LEDs 3 is disposed on the substrate 16 surrounding the axis of the transparent tube 4. As each electrode 5 is structured for enabling the same to fit into a corresponding terminal 10 through the opening 11 formed on top of the terminal 10, the LEDs can be conducted electrically with a control circuit that enables the control circuit to control the on and off of the plural LEDs 3 in a specific sequence and thus produce a cycling effect similar to the horse-race lamp. It is noted that the contacts between the two electrodes and the terminals 10 are only used for inducing electrical conduction between the control circuit and the plural LEDs 3, so that the shape and type of such terminal 10 may be varied with respect to those of the electrode 5 and the top-opened ring-like terminal 10 shown in FIG. 3B is only an embodiment. As the lamp 1B can be fitted into the aforesaid top-opened ring-like terminal at any angle that the angle of the transparent tube 4 being positioned will have no affect on the sequential-on/off of the plural LEDs 3, and further, it will have no way to resolve problems of glare, limited illuminant area and unable to produce luminance with sufficient evenness, and so on.

Generally, for coping with the deficiencies of LED that can only emit light in a particular direction, such as glare, limited illuminant area and unable to produce luminance with sufficient evenness, some bottom-lighting LED luminaires improves the aforesaid problems by aligning LEDs in a specific order and arrangement, while some others by adding lens on its LED light sources, and certain reflective/refractive LED luminaires deal with such problems by attaching a reflective/refractive cover to the luminaires. Take a bottom-light LED luminaire for example, although the abovementioned efforts help to improve the light efficiency thereof, but it can not vary the angle of the light being discharged out of the luminaire by adjusting the light-emitting angle of the LEDs and thus not only the light pattern preferred by a user can not be achieved, but also the uniformity of area to be lighted by the illumination device as well as the comfort of users is not preferred.

One such improved bottom-light LED luminaire is disclosed in U.S. Pat. No. 5,136,483, entitled “Illuminating Device”, as seen in FIG. 4. In FIG. 4, an illuminating device for use as a headlamp is comprised of: a plurality of LEDs 14, each being secured on a circumferential edge of the illuminating device; a light-reflecting cover 16; and a plurality of heat-dissipating fins 19; wherein, light beams emitted from the plural LEDs shine on the light-reflecting cover 16 are reflected thereby and thus being discharged out of the illuminating device in a parallel manner as the light-reflecting cover 16 is structured as a parabolic or elliptical surface. As each LED 14 is being placed flatly at the upper portion of the circumferential edge, the restricted light-emitting angle of such LED 14 will result that only a portion of light emitted therefrom can be reflected by the light-reflecting cover 16 and projected out of the illuminating device in a parallel manner while other portion will be either trapped inside the illuminating device, or being reflected out without shining on a preferred area specified by a user, so that the efficiency of the illuminating device is poor since not all light emitted from the LEDs 14 are utilized.

Another such improved bottom-light LED luminaire is disclosed in JP Pat. No. 2004327670, as seen in FIG. 5. The rotatable inclined LED arrangement of FIG. 5 is comprised of: an inclined-arranged LED 1, a substrate 2, a body 10, a strut 13 and a leg 11, in which a included angle formed between the LED 1 and the substrate 2 can be varied by adjusting a rotation angle of the body 10 with respect to the leg 11 and thus the LED arrangement is able to emit light in various directions. As there is no reflective means or refractive means being adapted in the LED arrangement, such LED arrangement is prone to suffer from glare. In addition, it can only adjust its light-emitting angle between 0 degree to 90 degree that an additional set of device is required if some other area out of the adjusting range is required to be illuminated. Moreover, when the LED 1 is broken and required to be replaced, the replacement operation requires to dismantle the substrate 2 as well which is very troublesome.

Another such improvement is a luminaire with reflector of negative focal length disclosed in U.S. Pub. No. 20060139933, entitled “Reflector With Negative Focal Length”. The luminaire with reflector of negative focal length is comprised of a light source and a luminaire screen having a reflector of negative focal length, a side screen and a plate. By the luminaire screen of the invention, the rays emitting from the light source of the luminaire are reflected and directed to a preferred discharging area so as to enable the rays to be discharge out of the luminaire by large angles for reducing glare.

Another such improvement is a light device disclosed in U.S. Pub. No. 20060232976, entitled “Lighting Device With Integration Sheet”. The light device with integration sheet is comprised of: a light source; and at least a sheet, each being disposed at the light emitting end of the light source and comprising a plurality of light diffusion zones; wherein each light diffusion zone has a plural arrays of microstructures arranged on the surface thereof, and each array of microstructures is capable of changing the diopter of the corresponding light diffusion zone. By controlling the distribution of the plural arrays of microstructures, the Gaussian distribution of the light source can be improved while collimating the scattered light beams to the intended illuminating area of the lighting device and diffusing the light beams emitting from the center of the light source to the same so that not only the luminous efficacy of the lighting device is enhanced, but also the uniformity of the illuminance of the lighting device is improved.

Another such improvement is a light guide apparatus disclosed in U.S. Pub. No. 20050129357, entitled “Light Guide Apparatus for Enhancing Light Source Utilization Efficiency”. The light guide apparatus for enhancing light source utilization efficiency includes: a light guide sheet; a light coupling structure, arranged on a surface of the light guide sheet and opposite to a light source; and a light emerging structure, disposed on a surface of light guide sheet; wherein lights emitted by the light source enters into the light guide sheet via the light coupling structure and evenly emitted to outer environment via said light emerging structure, thereby enhancing light source utilization efficiency.

Therefore, it is in needs of an illumination device of flexible lighting angle, that it can vary the angle of the light being discharged out of the illumination device by adjusting the light-emitting angle of the LEDs easily and produce illumination preferred by a user, while it is convenient when required to replace any broken LED used thereby.

### SUMMARY OF THE INVENTION

In view of the disadvantages of prior art, the primary object of the present invention is to provide an illumination device of flexible lighting angle, being an illumination device using light-emitting diodes (LEDs) as its light source and structured with a light-guide cover with light-control microstructure matching to the LEDs, which is capable of adjusting the light-emitting angle of its LED light source for directing every light emitted from its LED light source to impinge directly upon certain microsurfaces of the light-control microstructure with high efficiency so that not only the angle of the light being discharged out of the illumination device can be control effectively with respect to user's preference, but also the light pattern preferred by a user is achieved and the uniformity of area to be lighted by the illumination device is enhanced.

It is another object of the invention to provide an illumination device of flexible lighting angle, being an illumination device using light-emitting diodes (LEDs) as its light source, capable of replacing any one LED used thereby easily while it is broken or another LED of different color is preferred by a user as each LED is individually formed on a detachable base.

To achieve the above objects, the present invention provides an illumination device of flexible lighting angle, comprising:
at least a directional light source, each capable of emanating light as being electrically conducted to a control circuit and having ability to adjust a light-emitting angle thereof for varying the angle of the light being discharged therefrom;
a light guide cover, having a bottom and at least a light exit while each light exit being used for enabling light emitted from each directional light source to exit the light guide cover therefrom; and
at least a light-control microstructure, each formed on the light guide cover and composed of a plurality of microsurfaces;
wherein, by adjusting the light-emitting angle of each directional light source for directing the discharged light to shine on different microsurfaces of the light-control microstructure where it is reflected/refracted and discharged out of the light guide cover, the angle of the light being discharged out of the light guide cover is varied.

Preferably, the light-control microstructure is composed of a plurality of microsurfaces with different reflective/refractive characteristics.

Preferably, the light guide cover has a plurality of light-control microstructures formed thereon in a multi-layer formation of unparallel fashion as each layer is formed by one of the plural light-control microstructure and the microsurfaces formed on the light-control microstructure of different layer are not the same.

Preferably, a surface of each light-control microstructure where its microsurface is distributed can be a surface selected from the group consisted of a planar surface, a curved surface and the combination thereof. In another preferred aspect, the cross section of the microsurface-distributed surface of each light-control microstructure is symmetrical with respect to a central axis thereof whereas each semi-section of the microsurface-distributed surface can be a surface selected from the group consisting of an inclined surface, a curved surface and the combination thereof.

Preferably, the plural microsurfaces of each microsurface-distributed surface is formed thereon by a manner selected from the group consisting of an encircling manner, a symmetrical-distributing manner, a parallel-extending manner and the combination thereof.

Preferably, the light guide cover is made of a reflective material.

Preferably, a reflective layer is formed on an inner wall of the light guide cover.

Preferably, the reflective layer is formed by a means selected from the group consisting of the disposition of a reflective diffusion film and the electroplating a layer of metal, where as the metal can be aluminum or electroless nickel, etc.

In a preferred aspect, the at least one directional light source is disposed on an adjustment unit, each adjustment unit comprising:
a seat, being fixedly arranged inside the light guide cover; and
a movable part, being moveably mounted on the seat in an angle-adjustable manner, capable of receiving at least one direction light source.

Preferably, the adjustment unit is made of a material with thermal/electrical conductivity selected from the group consisting of iron, aluminum, magnesium, copper and the like, and the alloy thereof.

Preferably, the movable part is pivotally connected to the seat whereas the pivotal connection is achieved by inserting posts of the moveable part into retaining portions of the seat while enabling the posts to rotate freely in the retaining portions so as to enable the at least one direction light source received in the moveable part to rotate in full circumference.

Preferably, the seat comprises at least a holding part, whereas each holding part is configured with at least a retaining portion.

Preferably, the moveable part further comprises: a carrier surface, provided for the at least one directional light source to mounted thereon; and at least a post, each formed on the carrier surface at a position corresponding to the at least one retaining portion of the holding part.

By inserting the at least one post into the at least one retaining portion correspondingly for enabling the movable part to be pivotally connected to the seat, the at least one post is able to rotate freely in the corresponding retaining portion in full circumference with respect to an axis of the retaining portion.

Preferably, the seat comprises a plurality of the holding parts, being disposed on the seat in a manner that all the retaining portions of the plural holding parts are coaxial disposed.

Preferably, the carrier surface is arranged inside a transparent tube having two post-like axial ends.

Preferably, the transparent tube is made of a material selected from the group consisting of a glass, a plastic and the combination thereof.

Preferably, the movable part is pivotally connected to the seat whereas the pivotal connection is achieved by inserting the moveable part, shaped as a ball, into a ball-like retaining portion of the seat while enabling the ball to rotate freely in the ball-like retaining portion so as to enable the at least one direction light source received in the moveable part to rotate at any angle at will.

Preferably, the seat is configured with a ball-like retaining portion.

Preferably, the moveable part is shaped like a ball while being provided for the at least one directional light source to mount thereon.

By inserting the ball-shaped moveable part into the ball-like retaining portion of the seat, the movable part is pivotally connected to the seat while the ball-shaped moveable part is enabled to rotate freely in the ball-like retaining portion at any angle at will.

Preferably, the adjustment unit is a device of conductivity for enabling the same to conduct electricity between the at least one direction light source and the control circuit.

Preferably, each directional light source is a light emitting diode (LED).

Preferably, the at least one directional light source is connected to a protective circuit, whereas the protective circuit is composed of overload protection devices, such as fuse, and current regulator.

Preferably, there are a plurality of the directional light sources being fitted in the illumination device in a manner that they are disposed surrounding the light-control microstructure.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 shows a rotatable LED arrangement disclosed in U.S. Pat. No. 6,315,432, entitled “Light-emitting Diode (LED) device”.

FIG. 2 shows a rotatable LED arrangement disclosed in U.S. Pat. No. 6,450,663, entitled “Light-emitting Diode Arrangement”.

FIG. 3A shows a cycling LED lamp disclosed in JP Pat. 2002324405.

FIG. 3B is a cross-sectional view of FIG. 3A.

FIG. 4 shows an improved bottom-light LED luminaire is disclosed in U.S. Pat. No. 5,136,483, entitled “Illumination Device”.

FIG. 5 shows a rotatable inclined LED arrangement disclosed in JP Pat. 2004327670.

FIG. 6 shows a refractive illumination device according to a preferred embodiment of the invention.

FIG. 6A shows a path of a light beam as it is traveling between different media.

FIG. 7 shows a refractive illumination device according to another preferred embodiment of the invention.

FIG. 8 shows a refractive illumination device of the invention, being an integrated structure of two symmetrically arranged illumination devices of FIG. 6.

FIG. 9 shows another refractive illumination device of the invention, similar to that shown in FIG. 6 but with a two-layered light-control microstructure.

FIG. 10 shows a reflective illumination device according to a preferred embodiment of the invention.

FIG. 11 shows a reflective illumination device according to another preferred embodiment of the invention.

FIG. 12 shows a reflective illumination device of the invention, being an integrated structure of two symmetrically arranged illumination devices of FIG. 10.

FIG. 13 shows an illumination device with a plurality of directional light sources being fitted therein in a manner that they are disposed on a surrounding sidewall of a round-shaped light guide cover of the illumination device.

FIG. 14 shows an illumination device have a layer of refractive light-control microstructure and a layer of reflective light-control microstructure according to a preferred embodiment of the invention.

FIG. 15 shows an illumination device of the invention, being an integrated structure of an illumination device with refractive light-control microstructure and another illumination device with reflective light-control microstructure.

FIG. 16 is an exploded diagram illustrating an adjustment unit according to a preferred embodiment of the invention.

FIG. 17 shows an assembling of the adjustment unit of FIG. 16.

FIG. 18 shows an illumination device of the invention, being applied in a street lamp.

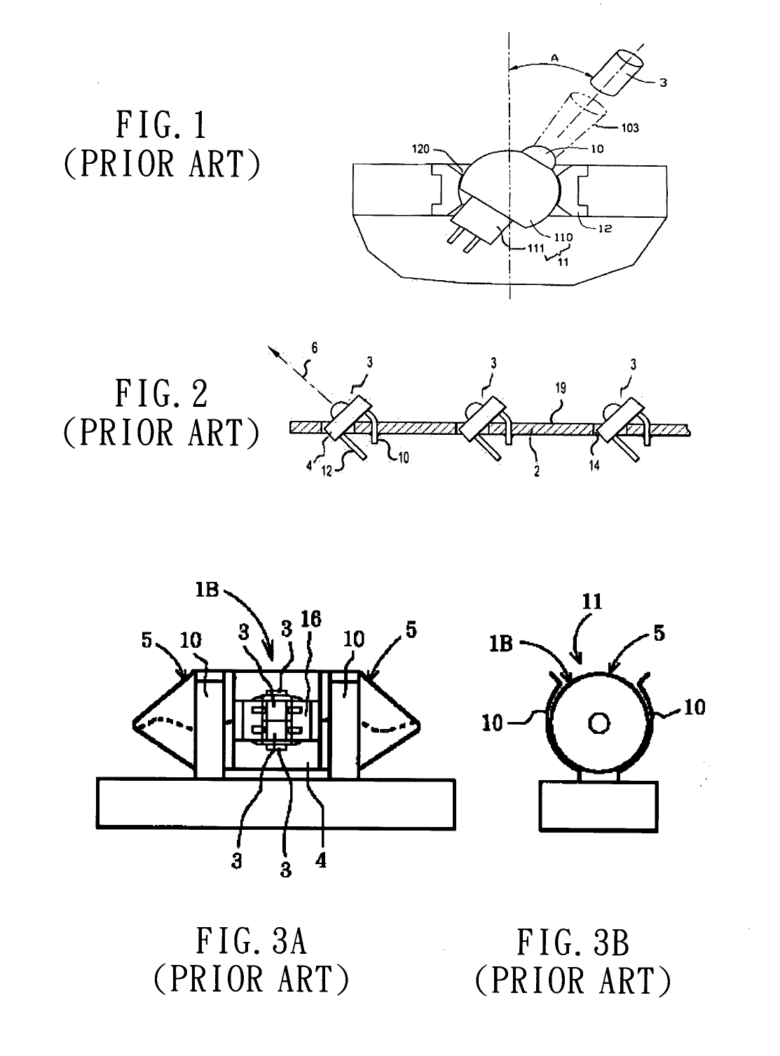

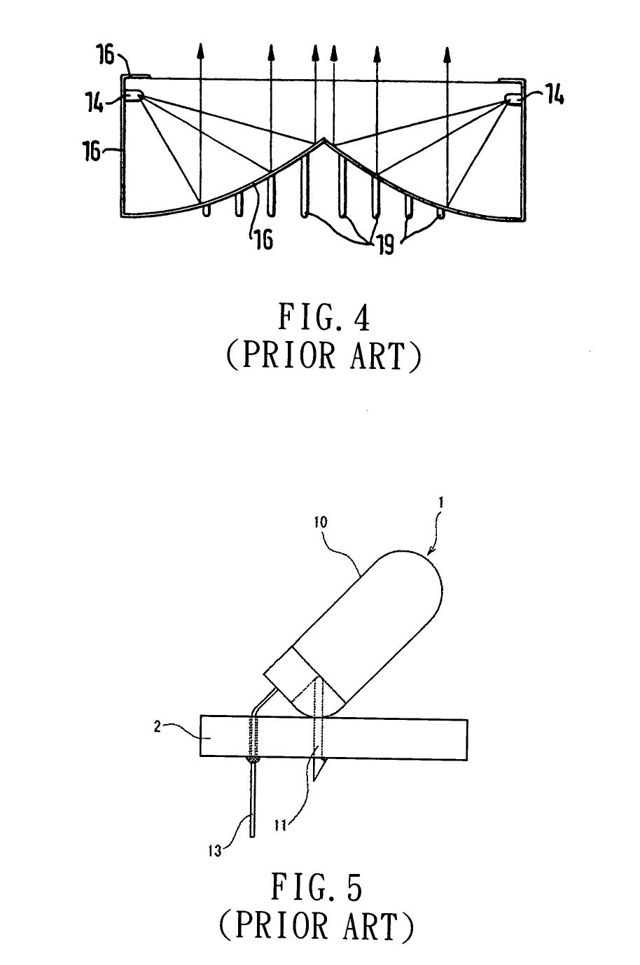

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

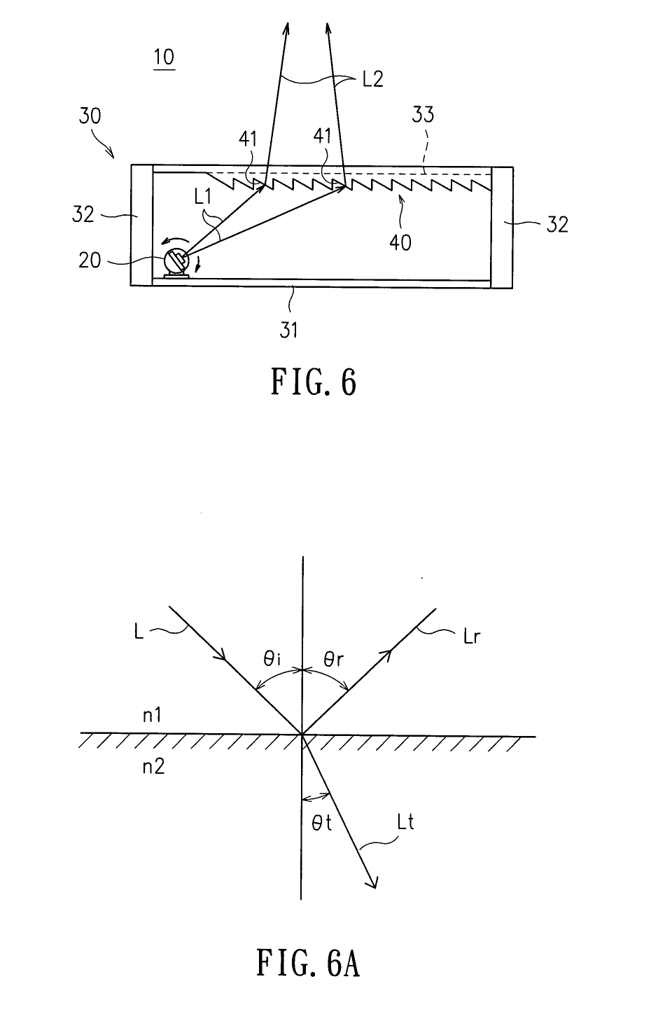

Please refer to FIG. 6, which shows a refractive illumination device according to a preferred embodiment of the invention. The refractive illumination device 10 uses a light emitting diode (LED) 20 as its light source that the LED 20, as a directional light source, can be replaced and substituted by another type of directional light source and thus is not limited thereby. The LED 20 is capable of emanating light as being electrically conducted to a control circuit and has ability to adjust a light-emitting angle thereof for varying the angle of the light being discharged therefrom. As seen in FIG. 6, the LED 20 is being received inside a light guide cover 30, which is composed of: a bottom 31; a sidewall 32, vertically arranged at the circumference of the bottom 31 while surrounding the same; and a projection surface 33, being disposed inside the enclosure of the sidewall 32 at a position corresponding to the bottom 31. Moreover, a light-control microstructure 40, composed of a plurality of microsurfaces 41 with refractive characteristics, is formed on the projection surface 33, whereas the combined structure of the projection surface 33 and the light-control microstructure 40 is so constructed for enabling light to pass therethrough. It is noted that the sawtooth-like surface of the light-control microstructure 40 is one possible structure capable of being achieved by the plural microsurface 41 which is used only for illustration and is not limited thereby as it can be any irregular surface composed of planar facets and curved facets.

It is known that refraction is the bending of the path of a light wave as it passes across the boundary separating two media that is caused by the change in speed experienced by a light wave when it changes medium. As seen in FIG. 6A, as a light bam is directed toward a boundary separating two media n1 and n2, a portion of the ray is reflected while the rest being refract, bending towards the normal (since the light is passing from a medium in which it travels fast, i.e. n1, into one in which it travels slow, i.e. n2. According to Snell's law, the refraction of light as it crosses from one material into a second material yields a general relationship between the sines of the angle of incidence, i.e. θᵢ, and the angle of refraction, i.e. θₜ. This general relationship is expressed by the following equation:

n₁ sin θᵢ=n₂ sin θₜ
whereas n₁ indicates the refraction index of the media n1;
   n₂ indicates the refraction index of the media n2; Moreover, according to the Law of Reflection that θᵢ, the angle of incidence, is equal to θᵣ, the angle of reflection, that is,

θᵢ=θᵣ

Therefore, as seen in FIG. 6, when the light L1 emitted from the LED 20 strikes on the plural microsurfaces 41 of the light-control microstructure 40, it is refracted as indicated by the refracted light L2 and being discharged out of the light guide cover 30. Furthermore, since the light-emitting angle of the LED 20 is adjustable, the position of the light L1 impinging upon the light-control microstructure 40 can be varied, the angle of the refracted light L2 being discharged out of the light guide cover 30 can be varied accordingly. In addition, as the bottom 31 and the sidewall 32 of the light guide cover 30 are chosen to be made of a reflective material, or either being covered by a reflective diffusion film or the electroplating of a layer of metal, such as aluminum or electroless nickel, etc., the reflection efficiency of the light guide cover 30 is enhanced.

In a preferred embodiment of the invention, a structure of Fresnel lens can be formed on the light-control microstructure 40. A Fresnel lens replaces the curved surface of a conventional lens with a series of concentric grooves, molded into the surface of a thin, lightweight sheet. The grooves act as individual refracting surfaces, like tiny prisms when viewed in cross section, bending parallel rays in a very close approximation to a common focal length. Thus, the Fresnel lens is a succession of concentric rings, each consisting of an element of a simple lens, assembled in proper relationship on a flat surface to provide a short focal length. Fresnel lenses are advantageous in its super light gathering/focusing ability that it is being vastly applied in various optical instruments. In addition to the aforesaid Fresnel lens, other optical structures, such as semi-Fresnel lens, can be formed on the light-control microstructure 40 as well, only if such optical structure can control the angle of the refracted light being discharged in a way the same as that of the microsurfaces 41 formed on the light-control microstructure 40.

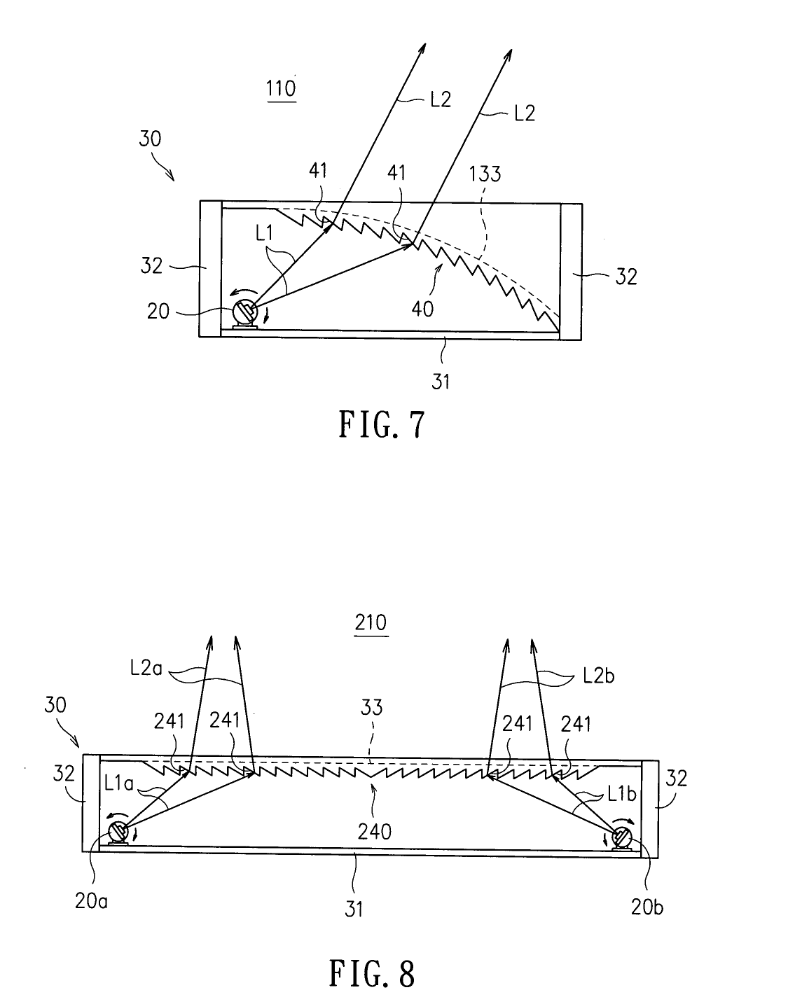

Please refer to FIG. 7, which shows a refractive illumination device according to another preferred embodiment of the invention. The refractive illumination device 10 is comprised of: at least an LED, each having ability to adjust a light-emitting angle thereof for varying the angle of the light being discharged therefrom; a light guide cover 30, having a bottom 31, a sidewall 32 and a projection surface 133, being disposed inside the enclosure of the sidewall 32 at a position corresponding to the bottom 31; and a light-control microstructure 40, formed on the projection surface 133. As the functions of the aforesaid components of the refractive illumination device 110 are similar to those of the refractive illumination device 10 and thus are not described further herein. The characteristic of the refractive illumination device 110 is that: the projection surface is a curved surface, whereas that of the refractive illumination device 11 is a planar surface, and thus the light-control microstructure 40 is formed with a curvature the same as that of the curved projection surface 133. Therefore, according to Snell's law, when the light L1 emitted from the LED 20 strikes on the plural microsurfaces 41 of the light-control microstructure 40, it is refracted as indicated by the refracted light L2 and being discharged out of the light guide cover 30 form the projection surface 33. Furthermore, since the light-emitting angle of the LED 20 is adjustable, the position of the light L1 impinging upon the light-control microstructure 40 can be varied, the angle of the refracted light L2 being discharged out of the light guide cover 30 can be varied accordingly.

Please refer to FIG. 8, which shows a refractive illumination device of the invention, being an integrated structure of two symmetrically arranged illumination devices of FIG. 6. The refractive illumination device 210 is comprised of: two LEDs 20a, 20b, symmetrically arranged with respect to an axis of the refractive illumination device 210, each having ability to adjust a light-emitting angle thereof for varying the angle of the light being discharged therefrom; a light guide cover 30, having a bottom 31, a sidewall 32 and a projection surface 33; and a light-control microstructure 240, formed on the projection surface 33; wherein, the on/off and the light-emitting angle of the two LEDs can be controlled independent to each other and thus the refractive illumination device 210 can be control to light-up at an one-sided mode whereas only one of the two LEDs 20a, 20b are turned on, or at a two-sided mode whereas both LEDs 20a, 20b are turned on. The characteristic of the refractive illumination device 210 is that: the light-control microstructure 240 are structured symmetrically with respect to the axis of the refractive illumination device 210 while enabling each half thereof to correspond to one of the two LEDs 20a, 20b. As the functions of the aforesaid components of the refractive illumination device 210 are similar to those of the refractive illumination device 10 and thus are not described further herein. Similarly, according to Snell's law, when the light L1a, L1b, emitted respectively from the LEDs 20a, 20b strike on the plural microsurfaces 241 of the light-control microstructure 240, they are refracted as indicated respectively by the refracted light L2a, L2b and being discharged out of the light guide cover 30 form the projection surface 33. Furthermore, since the light-emitting angles of the LED 20a, 20b are adjustable in a manner that they are adjusted independent to each other, the positions of the light L1a, L1b impinging upon the light-control microstructure 40 can be varied and strike at two different positions, the angles of the refracted light L2a, L2b, being discharged out of the light guide cover 30 can be varied accordingly. It is noted that the projection surface 33 where the light-control microstructure 240 is formed is a curved surface similar to that the curved projection surface 133 shown in FIG. 7.

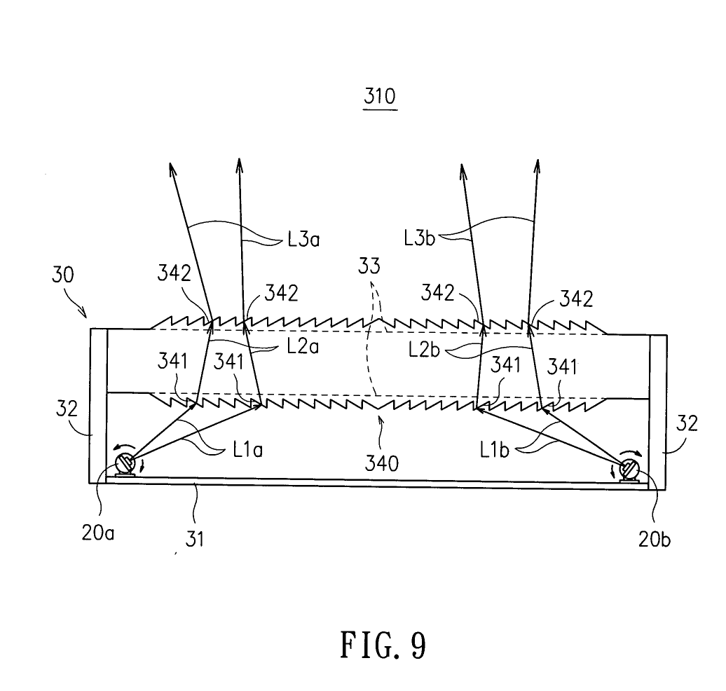

Please refer to FIG. 9, which shows another refractive illumination device of the invention, similar to that shown in FIG. 6 but with a two-layered light-control microstructure. The refractive illumination device 310 is comprised of: two LEDs 20a, 20b, symmetrically arranged with respect to an axis of the refractive illumination device 310, each having ability to adjust a light-emitting angle thereof for varying the angle of the light being discharged therefrom; a light guide cover 30, having a bottom 31, a sidewall 32 and a projection surface 33; and a two-layered light-control microstructure 340, formed on the projection surface 33; wherein, the on/off and the light-emitting angle of the two LEDs can be controlled independent to each other. As the functions of the aforesaid components of the refractive illumination device 310 are similar to those of the refractive illumination device 210 and thus are not described further herein. It is noted that the refractive illumination device 310 is characterized by the two-layered light-control microstructure 340, each having a plurality of microsurfaces formed thereon, respectively represented by the two layers of microsurfaces 341 and 342. Similarly, according to Snell's law, when the light L1a emitted from the LED 20a, strikes on the first layer of microsurfaces 341 of the light-control microstructure 340, it is refracted and directed to strike on the second layer of microsurfaces 342, as indicated by the refracted light L2a, where it is refracted again, as indicated by the refracted light L3a, to be discharged out of the light guide cover 30. In addition, as the control of the LED 20b is independent to that of the LED 20a, the LED 20b can emit a light L1b at an angle different to that of the LED 20a so that the light L1b will strike on a position of the two-layered light-control microstructure 340 different than the L1a. Thereby, when the light L1b emitted from the LED 20a, strikes on the first layer of microsurfaces 341 of the light-control microstructure 340, it is refracted and directed to strike on the second layer of microsurfaces 342, as indicated by the refracted light L2b, where it is refracted again, as indicated by the refracted light L3b, to be discharged out of the light guide cover 30. It is noted that the orientations of different layers of microsurfaces can be different from each other and thus are not limited to the parallel arrangement shown in FIG. 9. Moreover, as the light-emitting angles of the LED 20a, 20b are adjustable in a manner that they are adjusted independent to each other, the positions of the light L1a, L1b impinging upon the light-control microstructure 340 can be varied and strike at two different positions, the angles of the refracted light L3a, L3b, being discharged out of the light guide cover 30 can be varied accordingly.

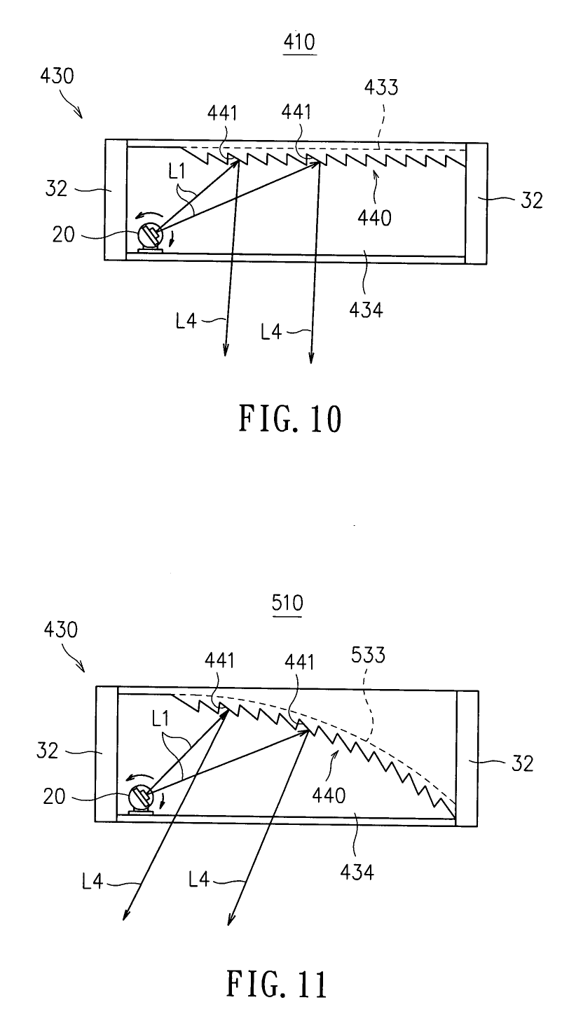

Please refer to FIG. 10, which shows a reflective illumination device according to a preferred embodiment of the invention. Different from the foregoing refractive illumination device, the illumination device shown in FIG. 10 is a reflective illumination device, comprising: an LED 20 with ability to adjust the light-emitting angle thereof; a light guide cover 430, having a projection surface 433 and a sidewall 32, vertically arranged at the circumference of the projection surface while surrounding the same; and a light exit 434, being disposed inside the enclosure of the sidewall 32 at a position corresponding to the projection surface 433. Moreover, a light-control microstructure 440, composed of a plurality of microsurfaces 441 with reflective characteristics, is formed on the projection surface 433, whereas the combined structure of the projection surface 433 and the light-control microstructure 440 is so constructed for enabling light to be reflected therefrom. It is noted that the sawtooth-like surface of the light-control microstructure 440 is one possible structure capable of being achieved by the plural microsurface 441 that is used only for illustration and is not limited thereby as it can be any irregular surface composed of planar facets and curved facets.

According to the Law of Reflection that θᵢ, the angle of incidence, is equal to θᵣ, the angle of reflection, when the light L1 emitted from the LED 20 strikes on the plural microsurfaces 441 of the light-control microstructure 440, it is reflected as indicated by the refracted light L4 and being discharged out of the light guide cover 430 from the light exit 434. Furthermore, since the light-emitting angle of the LED 20 is adjustable, the position of the light L1 impinging upon the light-control microstructure 40 can be varied, the angle of the reflected light L4 being discharged out of the light guide cover 430 can be varied accordingly. In addition, as the light guide cover 30 can be made of a reflective material, or the sidewall 32 thereof can either being covered by a reflective diffusion film or the electroplating of a layer of metal, such as aluminum or electroless nickel, etc., the reflection efficiency of the light guide cover 430 is enhanced

Please refer to FIG. 11, which shows a reflective illumination device according to another preferred embodiment of the invention. The reflective illumination device 510 shown in FIG. 11 is comprised of: an LED 20 with ability to adjust the light-emitting angle thereof; a light guide cover 430, having a projection surface 533 and a sidewall 32, vertically arranged at the circumference of the projection surface while surrounding the same; and a light exit 434, being disposed inside the enclosure of the sidewall 32 at a position corresponding to the projection surface 533. Moreover, a light-control microstructure 440, composed of a plurality of microsurfaces 441 with reflective characteristics, is formed on the projection surface 533. As the functions of the aforesaid components of the reflective illumination device 510 are similar to those of the refractive illumination device 410 of FIG. 10 and thus are not described further herein. The characteristic of the reflective illumination device 510 is that: the projection surface 533 is a curved surface, whereas that of the reflective illumination device 410 is a planar surface, and thus the light-control microstructure 440 is formed with a curvature the same as that of the curved projection surface 533. Therefore, according to Law of Reflection, when the light L1 emitted from the LED 20 strikes on the plural microsurfaces 441 of the light-control microstructure 440, it is reflected as indicated by the refracted light L4 and being discharged out of the light guide cover 430 form the light exit 434. Furthermore, since the light-emitting angle of the LED 20 is adjustable, the position of the light L1 impinging upon the light-control microstructure 440 can be varied, the angle of the refracted light L4 being discharged out of the light guide cover 430 can be varied accordingly.

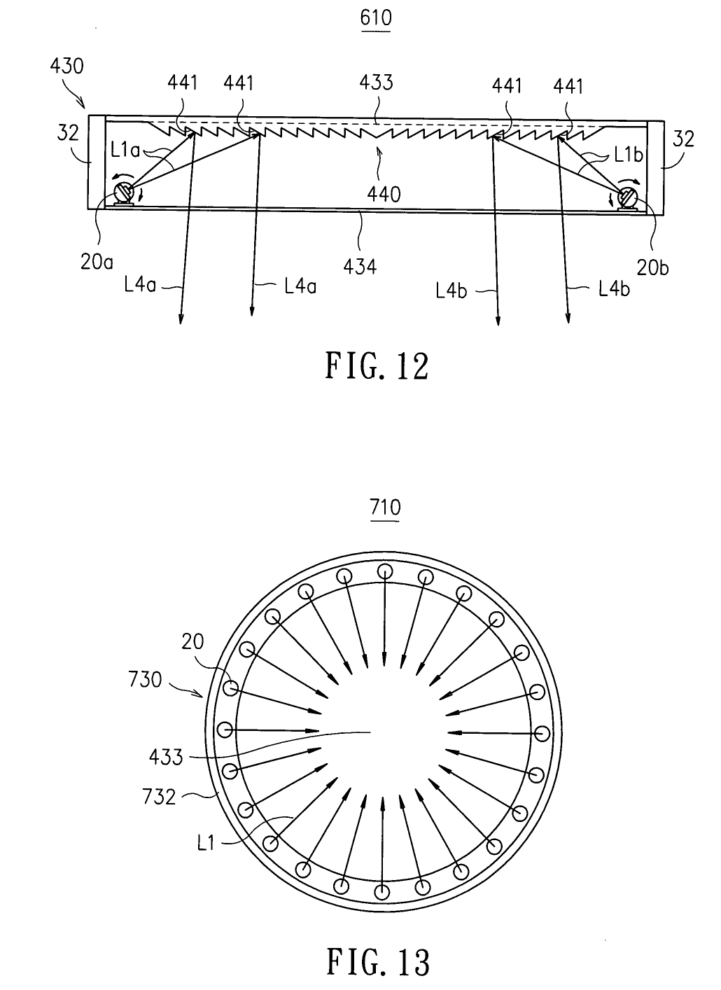

Please refer to FIG. 12, which shows a reflective illumination device of the invention, being an integrated structure of two symmetrically arranged illumination devices of FIG. 10. The reflective illumination device 610 is comprised of: two LEDs 20a, 20b, symmetrically arranged with respect to an axis of the refractive illumination device 610, each having ability to adjust a light-emitting angle thereof for varying the angle of the light being discharged therefrom; a light guide cover 430, having a sidewall 32, a projection surface 433 and a light exit 434; and a light-control microstructure 440, formed on the projection surface 433 at a side thereof facing toward the light exit 434; wherein, the on/off and the light-emitting angle of the two LEDs can be controlled independent to each other and thus the refractive illumination device 610 can be control to light-up at an one-sided mode whereas only one of the two LEDs 20a, 20b are turned on, or at a two-sided mode whereas both LEDs 20a, 20b are turned on. The characteristic of the refractive illumination device 610 is that: the light-control microstructure 440 are structured symmetrically with respect to the axis of the refractive illumination device 21 while enabling each half thereof to correspond to one of the two LEDs 20a, 20b. As the functions of the aforesaid components of the reflective illumination device 610 are similar to those of the refractive illumination device 410 and thus are not described further herein. Similarly, according to the Snell's law, when the light L1a, L1b, emitted respectively from the LEDs 20a, 20b strike on the plural microsurfaces 441 of the light-control microstructure 440, they are reflected as indicated respectively by the reflected light L4a, L4b and being discharged out of the light guide cover 430 form the light exit 434. Furthermore, since the light-emitting angles of the LED 20a, 20b are adjustable in a manner that they are adjusted independent to each other, the positions of the light L1a, L1b impinging upon the light-control microstructure 440 can be varied and strike at two different positions, the angles of the refracted light L4a, L4b, being discharged out of the light guide cover 430 can be varied accordingly. It is noted that the projection surface 433 where the light-control microstructure 440 is formed can be a curved surface similar to that the curved projection surface 533 shown in FIG. 11.

Please refer to FIG. 13, which shows an illumination device with a plurality of directional light sources being fitted therein in a manner that they are disposed on a surrounding sidewall of a round-shaped light guide cover of the illumination device. As seen in FIG. 13, the illumination device 710 is configured with a round-shaped light guide cover 730, whose surrounding sidewall 732 is fitted with a plurality of LEDs 20 in a manner that all the light L1 emitted from the plural LEDs are directed toward the center of the round-shaped light guide cover 730. With such arranging of the LEDs 20 at the round-shaped light guide cover 730, no matter it is paired to work with a light-control microstructure 40 with refractive characteristics as that shown in FIG. 6 or another light-control microstructure 440 with reflective characteristics as that shown in FIG. 10, the light L1 can all be reflected or refracted into a single light beam to be discharged out of the light guide cover 730. However, as the light-emitting angles of the plural LED 20 are adjustable in a manner that they can be adjusted independent to each other, each LED 20 can be adjust to have different light-emitting angles so that there may be various light beams being discharged out of the light guide cover 730 in different directions.

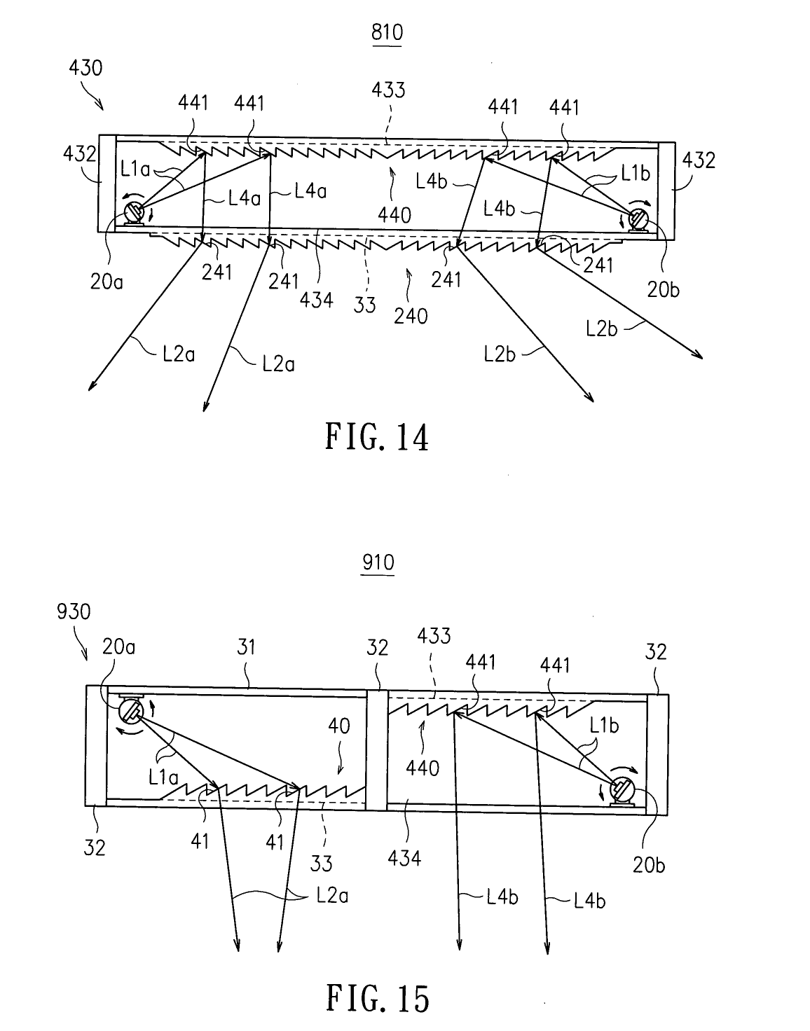

Please refer to FIG. 14, which shows an illumination device have a layer of refractive light-control microstructure and a layer of reflective light-control microstructure according to a preferred embodiment of the invention. The illumination device 810 is comprised of: two LEDs 20a, 20b, symmetrically arranged with respect to an axis of the illumination device 810, each having ability to adjust a light-emitting angle thereof for varying the angle of the light being discharged therefrom; a light guide cover 430, having a sidewall 432, a projection surface 433 and a light exit 434; and a reflective light-control microstructure 440, formed on the projection surface 433 at a side thereof facing toward the light exit 434. As the functions of the aforesaid components of the reflective illumination device 810 are similar to those of the refractive illumination device 410 and thus are not described further herein. The characteristic of the illumination device 810 is that: an additional light-control microstructure 240 having refractive microsurface 241 is formed on a projection surface of the light exit 434. Thus, according to the Snell's law and Law of Reflection, when the light L1a emitted respectively from the LED 20a strike on the plural reflective microsurfaces 441 of the light-control microstructure 440, they are reflected as indicated by the reflected light L4a and directed to strike on the refractive microsurface 241 of the additional light-control microstructure 240, where it is refracted and forms a refracted light L2a, to be discharged out of the light guide cover 430. In addition, as the control of the LED 20b is independent to that of the LED 20a, the LED 20b can emit a light L1b at an angle different to that of the LED 20a so that the light L1b will strike on a position of the reflective light-control microstructure 440 different than the L1a. Thereby, when the light L1b emitted from the LED 20a, strikes on the reflective microsurfaces 441 of the light-control microstructure 440, it is reflected, as indicated by the reflected light L4b, and directed to strike on the refractive microsurfaces 241 of the additional light-control microstructure 240, where it is refracted to form a refracted light L2b and discharged out of the light guide cover 430, whereas the refracted light L2b is being discharged out of the light guide cover 430 at an angle different than that of the refracted light L2a. It is noted that the projection surfaces 33, 433 where the light-control microstructures 240, 440 are formed respectively, can each be a curved surface similar to that the curved projection surfaces 133, 533 respectively shown in FIG. 7 and FIG. 11.

Please refer to FIG. 15, which shows an illumination device of the invention, being an integrated structure of an illumination device with refractive light-control microstructure and another illumination device with reflective light-control microstructure. The illumination device 910 can be considered as an integrated structure of the refractive illumination device 10 of FIG. 6 and the reflective illumination device 410 of FIG. 10. As seen in FIG. 15, an additional sidewall is arranged at the middle portion of the light guide cover 930 of the illumination device 910 while a refractive device similar to the refractive illumination device 10 of FIG. 6 is positioned at the left of the light guide cover 930 and another device similar to the reflective illumination device 410 of FIG. 10 is positioned at the right of the light guide cover 930. For enabling the light to be discharged out of the illumination device 910 from the same side thereof, that is, the reflected light of the reflective device is discharged out of the illumination device from the side thereof the same as that of the refractive device, it is required to position the reflective device up-side-down with respect to the refractive device, and vice versa. With the aforesaid integrated structure, the reflected light L4b of the light L1b emitted by the LED 20b and the refracted light L2a of the light L1a emitted by the LED 20a can be directed to discharge out of the light guide cover 930 form the same side thereof. Similarly, all the other illumination devices can be integrated into an integrated illumination device in a manner similar to that shown in FIG. 15, by which various lighting effects can be achieved.

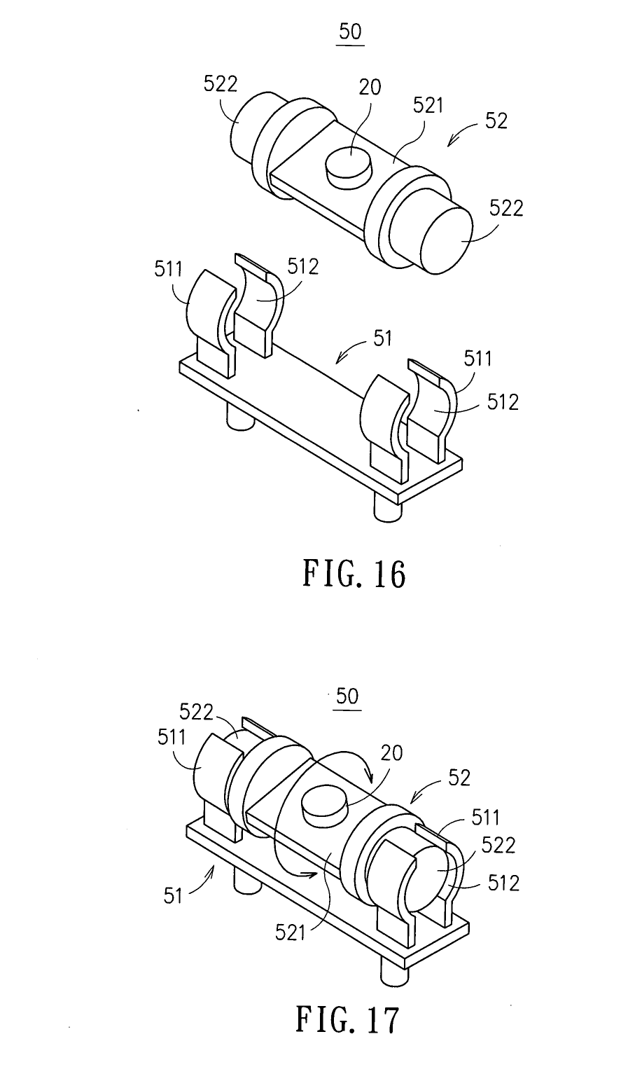

In a preferred aspect, the light guide cover has a plurality of light-control microstructures formed thereon in a multi-layer formation as each layer is formed by one of the plural light-control microstructure and the microsurfaces formed on the different layer of the multi-layered light-control microstructure. In addition, a surface of each light-control microstructure where its microsurface is distributed can be a surface selected from the group consisted of a planar surface, a curved surface and the combination thereof. In another preferred aspect, the cross section of the microsurface-distributed surface of each light-control microstructure is symmetrical with respect to a central axis thereof whereas each semi-section of the microsurface-distributed surface can be a surface selected from the group consisting of an inclined surface, a curved surface and the combination thereof. Thus, with respect to the structure of the light-control microstructure 240, the plural microsurfaces of each microsurface-distributed surface is formed thereon by a manner selected from the group consisting of an encircling manner, a symmetrical-distributing manner, a parallel-extending manner and the combination thereof, whereas the manner is selected matching the arrangement of LEDs as well as the light-emitting angles corresponding to the LED arrangement. Please refer to FIG. 16 and FIG. 17, which are respectively an exploded diagram illustrating an adjustment unit according to a preferred embodiment of the invention and the assembly thereof. As seen in the figures, an LED 20 is mounted on an adjustment unit 50, which is comprised of a seat 51 and a moveable part 52. The seat 51 is fixedly arranged inside a light guide cover, such as the light guide cover 30 shown in FIG. 6, that the seat 51 is configured with at two holding parts 511, being arranged at positions corresponding to each other while enabling retaining portions 512 of the two holding parts to be coaxially arranged. Moreover, the moveable part 52 is configured with a carrier surface 521, provided for the LED 20 to mounted thereon, and two posts 522, each formed on the carrier surface 521 at a position enabling the same to correspondent to a retaining portions 512. Thus, by inserting each post 522 into its corresponding retaining portion 512, the movable part 52 can be pivotally connected to the seat 51 since the two posts 522 are able to rotate freely in the corresponding retaining portion 512 in full circumference with respect to an axis of the retaining portions 512 and the posts 522. In a preferred embodiment, the LED 20 is a chip-type LED, and the seat 51 as well as the moveable part 50 are all made of a material with thermal/electrical conductivity selected from the group consisting of iron, aluminum, magnesium, copper and the like, and the alloy thereof. As the adjustment unit 50 is made of the material with thermal/electrical conductivity, the heat generated from the operating LED 20 can de dissipated therefrom rapidly. Moreover, as the LED 20 is designed with good heat-dissipating ability, it can be received in a transparent tube for protecting the same and the tube can be made of a material selected from the group consisting of a glass, a plastic and the combination thereof. In a preferred aspect, the LED 20 is connected to a protective circuit, composed of overload protection devices, such as fuse, and current regulator, so that the lifespan of the LED 20 can be prolonged.

It is noted that the adjustment unit 50 shown in FIG. 16 and FIG. 14 is only an illustration and is not limited thereby. In another preferred embodiment, the seat 51 is configured with a ball-like retaining portion 512 and the moveable part 52 is shaped like a ball while being provided for the LED to mount thereon. By inserting the ball-shaped moveable part 52 into the ball-like retaining portion 512 of the seat 51, the movable part 52 is pivotally connected to the seat 51 while the ball-shaped moveable part 52 is enabled to rotate freely in the ball-like retaining portion 512 at any angle at will.

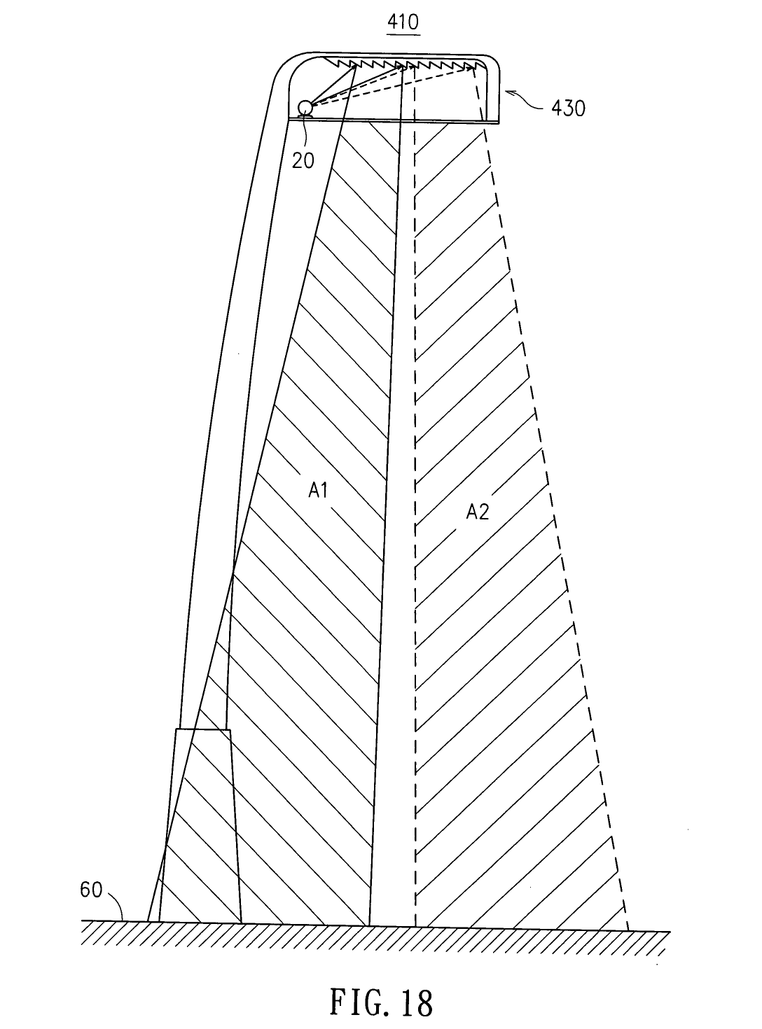

Please refer to FIG. 18, which shows an illumination device of the invention, being applied in a street lamp. While an reflective illumination device 410 as that shown in FIG. 10 is being applied in a street lamp, the angle of the light being discharged out of the light guide cover 430 can be varied with the adjustment of the light-emitting angle of the LED 20. Thereby, The street lamp is enabled to illuminate different areas, such as the two areas A1 and A1 shown in FIG. 18 and thus light-up different areas of the ground 60 correspondingly. When an illumination device with a plurality of LEDs 20 being fitted therein in a manner that they are disposed on a surrounding sidewall of a round-shaped light guide cover of the illumination device, as that shown in FIG. 13, is being applied in a street lamp, the light being discharged out of the street lamp can have various geometrical shapes, such as oval shape or circular shape, with respect to the adjustment of the light-emitting angle of each LED 20. Similarly, the refractive illumination device 10 as that shown in FIG. 6 can also achieve the same effect.

To sum up, the illumination device of the invention is an illumination device capable of varying the angle of the light being discharged out of the illumination device by adjusting the light-emitting angle of its light sources with respect to a use's preference and the same time matching the adjustment with a light-control structure formed on its light guide cover, by which not only glare can be eliminated, but also the light pattern and the angle of the light being discharged out of the light guide cover preferred by a user can be achieved so that the illumination devices is enabled to be more versatile since it is freed from the restrictions limiting the appearance design of the light cover as well as those limiting the manufacturing of LED circuits. In addition, as the shape of each LED used in the illumination device of the invention can be standardized to be mounted on a standardized seat fitted in the illumination device, it is easy to be altered with respect to the preference of a user that the illumination device of the invention is a device characterized by its high light efficiency, easy to maintain, flexibility, light weight and compact design.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An illumination device of flexible lighting angle, comprising:
at least a directional light source, each capable of emanating light as being electrically conducted to a control circuit and having ability to adjust a light-emitting angle thereof for varying the angle of the light being discharged therefrom;
a light guide cover, capable of receiving the at least one directional light source therein; and
at least a light-control microstructure, each formed in the light guide cover and composed of a plurality of microsurfaces;
wherein, by adjusting the light-emitting angle of each directional light source for directing the discharged light to shine on different microsurfaces of the light-control microstructure where it is discharged out of the light guide cover, the angle of the light being discharged out of the light guide cover is varied.

2. The illumination device of claim 1, wherein the light-control microstructure is composed of a plurality of microsurfaces with different reflective/refractive characteristics.

3. The illumination device of claim 2, wherein the light guide cover further comprises a light exit having a plurality of microsurfaces with refractive characteristics to be formed thereat, used for enabling light emitted from the at least one directional light source to exit the light guide cover therefrom.

4. The illumination device of claim 2, wherein the light guide cover has a plurality of light-control microstructures formed thereon in a multi-layer formation of unparallel fashion as each layer is formed by one of the plural light-control microstructure; and the microsurfaces formed on the light-control microstructure of different layer are not the same.

5. The illumination device of claim 1, wherein a surface of each light-control microstructure where its microsurface is distributed can be a surface selected from the group consisted of a planar surface, a curved surface and the combination thereof, while the cross section of the microsurface-distributed surface of each light-control microstructure is symmetrical with respect to a central axis thereof whereas each semi-section of the microsurface-distributed surface can be a surface selected from the group consisting of an inclined planar surface, a curved surface and the combination thereof.

6. The illumination device of claim 1, wherein the plural microsurface of each microsurface-distributed surface is formed thereon by a manner selected from the group consisting of an encircling manner, a symmetrical-distributing manner, a parallel-extending manner and the combination thereof.

7. The illumination device of claim 1, wherein the light guide cover is made of a reflective material.

8. The illumination device of claim 1, wherein a reflective layer is formed on an inner wall of the light guide cover.

9. The illumination device of claim 8, wherein the reflective layer can be a reflective diffusion film or an electroplated coating of aluminum or electroless nickel, etc.

10. The illumination device of claim 1, wherein the at least one directional light source is disposed on an adjustment unit, each adjustment unit comprising:
a seat, being fixedly arranged inside the light guide cover; and
a rotatable part, being rotatably mounted on the seat in an angle-adjustable manner, capable of receiving at least one direction light source.

11. The illumination device of claim 10, wherein the adjustment unit is made of a material with thermal/electrical conductivity selected from the group consisting of iron, aluminum, magnesium, copper and the like, and the alloy thereof.

12. The illumination device of claim 10, wherein the rotatable part is pivotally connected to the seat whereas the pivotal connection is achieved by inserting posts of the rotatable part into retaining portions of the seat while enabling the posts to rotate freely in the retaining portions so as to enable the at least one direction light source received in the rotatable part to rotate in full circumference.

13. The illumination device of claim 12, wherein the seat is configured with at least a holding part, whereas each holding part is configured with at least a retaining portion; and the rotatable part is configured with a carrier surface, provided for the at least one directional light source to mounted thereon, and at least a post, each formed on the carrier surface at a position corresponding to the at least one retaining portion of the holding part; thus, by inserting the at least one post into the at least one retaining portion correspondingly for enabling the rotatable part to be pivotally connected to the seat, the at least one post is able to rotate freely in the corresponding retaining portion in full circumference with respect to an axis of the retaining portion.

14. The illumination device of claim 13, wherein the seat comprises a plurality of the holding parts, being disposed on the seat in a manner that all the retaining portions of the plural holding parts are coaxial disposed.

15. The illumination device of claim 13, wherein the carrier surface is arranged inside a transparent tube having two post-like axial ends.

16. The illumination device of claim 15, wherein the transparent tube is made of a material selected from the group consisting of a glass, a plastic and the combination thereof.

17. The illumination device of claim 10, wherein the rotatable part is pivotally connected to the seat whereas the pivotal connection is achieved by inserting the rotatable part, shaped as a ball, into a ball-like retaining portion of the seat while enabling the ball to rotate freely in the ball-like retaining portion so as to enable the at least one direction light source received in the rotatable part to rotate at any angle at will.

18. The illumination device of claim 17, wherein the seat is configured with a ball-like retaining portion; and the rotatable part is shaped like a ball while being provided for receiving the at least one directional light source; thus, by inserting the ball-shaped rotatable part into the ball-like retaining portion of the seat, the rotatable part is pivotally connected to the seat while the ball-shaped rotatable part is enabled to rotate freely in the ball-like retaining portion at any angle at will.

19. The illumination device of claim 10, wherein the adjustment unit is able to conduct electricity between the at least one direction light source and the control circuit.

20. The illumination device of claim 10, wherein each directional light source is a light emitting diode (LED).

21. The illumination device of claim 10, wherein the at least one directional light source is connected to a protective circuit, whereas the protective circuit is composed of overload protection devices, such as fuse, and current regulator.

22. The illumination device of claim 10, wherein there are a plurality of the directional light sources being fitted in the illumination device in a manner that they are disposed surrounding the light-control microstructure.

23. A refractive illumination device of flexible lighting angle, comprising:
at least a directional light source, each capable of emanating light as being electrically conducted to a control circuit and having ability to adjust a light-emitting angle thereof for varying the angle of the light being discharged therefrom;
a light guide cover having a projection surface, capable of receiving the at least one directional light source therein; and
at least a light-control microstructure, each formed on the projection surface of the light guide cover and composed of a plurality of microsurfaces of refractive characteristics;
wherein, by adjusting the light-emitting angle of each directional light source for directing the discharged light to shine on different microsurfaces of the light-control microstructure where it is refracted and discharged out of the light guide cover, the angle of the light being discharged out of the light guide cover is varied.

24. A reflective illumination device of flexible lighting angle, comprising:
at least a directional light source, each capable of emanating light as being electrically conducted to a control circuit and having ability to adjust a light-emitting angle thereof for varying the angle of the light being discharged therefrom;
a light guide cover having a projection surface and at least a light exit, capable of receiving the at least one directional light source therein; and
at least a light-control microstructure, each formed on the projection surface of the light guide cover and composed of a plurality of microsurfaces of reflective characteristics;
wherein, by adjusting the light-emitting angle of each directional light source for directing the discharged light to shine on different microsurfaces of the light-control microstructure where it is reflected and discharged out of the at least one light exit of the light guide cover, the angle of the light being discharged out of the light guide cover is varied.
